(19) United States
(12) Patent Application Publication
(10) Pub. No.: US 2005/0207063 A1
(43) Pub. Date: Sep. 22, 2005

(54) Disk cartridge

(75) Inventors: Harumi Aoishi, Odawara-shi (JP); Hideaki Shiga, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/082,786

(22) Filed: Mar. 18, 2005

(30) Foreign Application Priority Data
Mar. 18, 2004 (JP) 078232/2004

(51) Int. Cl. G11B 23/03

(52) U.S. Cl. 360/133

(57) ABSTRACT

A disk cartridge is provided, in which occurrence of distortion is prevented in a data region located at the radially outer part of a disk-shaped flexible information recording medium secured on a center core. A protrusion is formed integrally with the rotary shutter on a facing surface of the rotary shutter on the side facing an information recording medium. A liner for wiping off dirt deposited on the information recording medium is affixed to the protrusion.

### BACKGROUND OF THE INVENTION

1. Field of the Invention

The present invention relates to a disk cartridge which rotatably accommodates a flexible disk-shaped information recording medium, and more particularly to a disk cartridge using an insert molded center core.

2. Description of the Related Art

Conventionally, mobile equipment such as digital cameras use very small magnetic disk cartridges called “clik!™” or “PocketZip™” as recording media (see, for example, Japanese Unexamined Patent Publication No. 2002-050151). Such a disk cartridge, for example, comprises an information recording medium, about 1.8 inch (46.5 mm) in diameter, which is a magnetic disk with a 40 MB storage capacity; and a housing (width 50 mm, depth 55 mm, thickness 1.95 mm) which has upper and lower shells formed of a flat thin metal sheet and rotatably accommodates therein the information recording medium.

In the aforesaid disk cartridge, any dust and foreign matter adhering to a magnetic disk accommodated therein may cause so-called ‘dropout’, i.e., loss of recording/reproduction signals. This dropout problem tends to occur more easily as the recording density of the magnetic disk increases. Accordingly, for the purpose of removing the dust and foreign matter from the magnetic disk and keeping the surface of the magnetic disk clean, the disk cartridge has a structure in which a liner is affixed on each inner surface of the cartridge on the side facing the information recording medium. In the conventional magnetic disk cartridges, a liner, which is formed of a material having a napped surface to be contacted with the magnetic disk, is used. Specifically, the napped surface of the liner is brought into contact with the rotating magnetic disk so that the dust and/or foreign matter on the magnetic disk are wiped off and captured thereby.

Recently, there is a need for reduction in power consumption of disk cartridges for personal computers, PDAs, and mobile equipment such as digital cameras when the disk cartridge undergoes recording or reproducing, as well as reduction in size and increase in storage capacity (for example, up to 1 GB) of the disk cartridges. Approaches for reducing the power consumption include rotating a magnetic disk within a disk cartridge with a low torque. In order to rotate the magnetic disk with a low torque, it is necessary to reduce the sliding friction between the magnetic disk and a liner. If the sliding friction between the magnetic disk and the liner is reduced, however, there arises a problem that foreign matter deposited on the surface of the magnetic disk cannot be wiped off sufficiently, thereby causing read/write errors.

### SUMMARY OF THE INVENTION

In view of the foregoing, an object of the invention is to provide a disk cartridge which can reliably remove dirt deposited on an information recording medium and can achieve power savings when the information recording medium is rotated.

In accordance with the present invention, there is provided a disk cartridge comprising a disk-shaped information recording medium; and a flat housing in which the recording medium is rotatably accommodated, the housing including an opening to allow a read/write head of a drive unit to access a surface of the information recording medium, and a rotary shutter for opening and closing the opening, wherein a protrusion is formed integrally with the rotary shutter on a facing surface of the rotary shutter on the side facing or opposite the information recording medium, and a liner for wiping off dirt deposited on the information recording medium is affixed to the protrusion.

According to the present invention, the protrusion may be formed by any method so long as the protrusion is integrally formed with the rotary shutter. For example, the protrusion may be formed in relief on the facing surface by stamping the rotary shutter from the side away from the information recording medium. Alternatively, the protrusion may be formed beforehand on the facing surface when the rotary shutter is produced.

Further, the protrusion may be located at any position on the rotary shutter so long as the protrusion is integrally formed with the rotary shutter. For example, the protrusion may be disposed near the opening of the rotary shutter.

In addition, so long as the protrusion protrudes from the facing surface towards the information recording medium, the number and shape of protrusions can be selected as desired. For example, a single protrusion or a plurality of protrusions that extend from a radially inner portion to a radially outer portion of the rotary shutter may be provided, or a plurality of point-like protrusions may be provided.

When the protrusion is provided to extend from a radially inner portion to a radially outer portion of the rotary shutter, the height of the protrusion may be uniform along its entire length or may be different between the radially inner portion and radially outer portion.

The protrusions may be provided on each of the two facing surfaces of the rotary shutter on the side facing the information recording medium. Alternatively, the protrusions may be provided only one of the facing surfaces. When the protrusions are provided on each of the two facing surfaces of the rotary shutter, the protrusions on one facing surface may be disposed facing the protrusions on the other facing surface or may be disposed circumferentially offset from the protrusions on the other facing surface.

The liner needs to be affixed at least to the protrusion. For example, the liner may be affixed only to the protrusion, or may be affixed to the entire facing surface including the protrusion.

According to the disk cartridge of the invention, a rotary shutter has a protrusion that is formed integrally therewith on a facing surface of the rotary shutter on the side facing an information recording medium, in a manner projecting from the facing surface towards the information recording medium. A liner for wiping off dirt deposited on the information recording medium is affixed to the protrusion. Therefore, the portion of the liner disposed on the protrusion formed on the facing surface comes into contact with the information recording medium, as a result of which, dirt deposited on the information recording medium can be reliably removed and a torque required for rotating the information can be reduced, thereby saving the power consumption for rotating the information recording medium.

When the protrusion is formed to extend in a radial direction of the rotary shutter, the liner comes into contact with the information recording medium from the radially inner end portion to the radially outer end portion of the information recording medium. Accordingly, deposited dirt can be reliably removed from the entire surface of the information recording medium.

### BRIEF DESCRIPTION OF THE DRAWINGS

FIG. 1A is a plan view and FIG. 1B is a bottom view of a disk cartridge according to a preferred embodiment of the invention with the rotary shutter being closed;

FIG. 2 is a sectional view of a part of the disk cartridge in FIG. 1, showing the periphery of the center core;

FIG. 3 is a perspective view showing, by way of example, an external appearance of the rotary shutter of the disk cartridge in FIG. 1.

FIG. 4 is a sectional view of a part of the disk cartridge in FIG. 3, showing the periphery of the protrusion;

FIG. 5 is a sectional view of a variant of the rotary shutter of the disk cartridge shown in FIG. 1; and

FIG. 6A and FIG. 6B are views showing other variants of the rotary shutter of the disk cartridge shown in FIG. 1.

### DESCRIPTION OF THE PREFERRED EMBODIMENTS

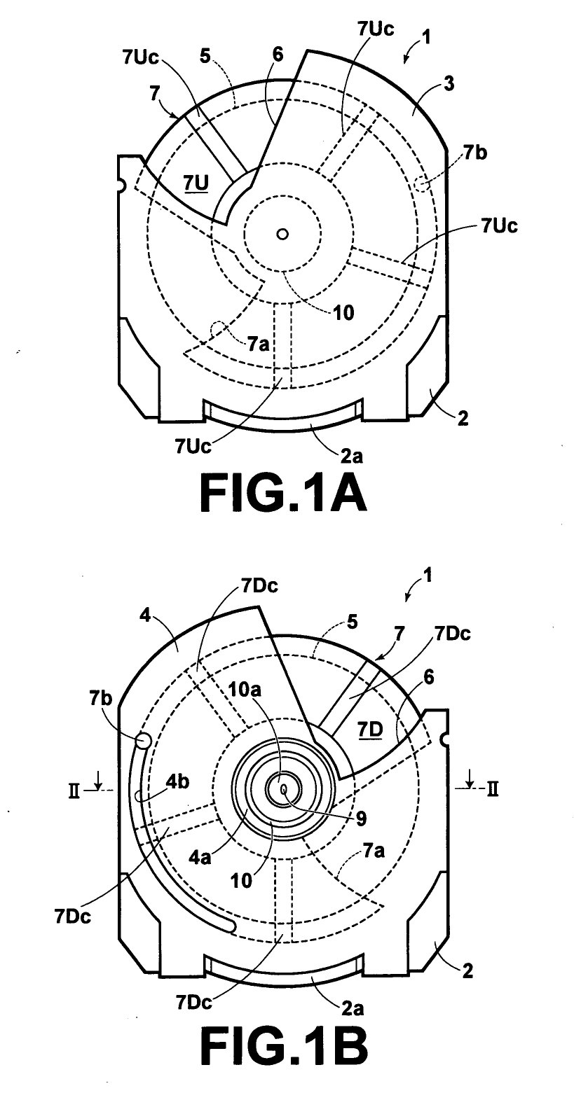

Hereinafter, an embodiment of the present invention will be described in detail with reference to the drawings. FIGS. 1A and 1B are plan and bottom view of an example of a disk cartridge according to an embodiment of the invention, with a rotary shutter 7 being closed.

The disk cartridge 1 comprises: a flat housing (width 50 mm, depth 55 mm, thickness 1.95 mm) constituted by a resin frame 2 (usually called “stabilizer”) including a push portion 2a for pushing the disk cartridge into a disk drive; upper and lower shells 3, 4 formed of a thin metal sheet; and an information recording medium 5 that is a 1.8″ (46.5 mm) diameter magnetic disk and rotatably accommodated in the flat housing.

The housing of the magnetic disk cartridge has a wedge-shaped opening 6 to allow a magnetic head of a drive device to access the surface of the information recording medium 5, and a rotary shutter 7 for opening and closing the opening 6. When the disk drive writes or reads information to and from the information recording medium, the rotary shutter 7 is opened and the magnetic head is inserted through the opening 6. Meanwhile, when the magnetic head is removed and the recording medium 5 is not in use, the rotary shutter 7 is closed to be positioned across the opening 6, thereby preventing the entry of dust or foreign matter into the disk cartridge.

The lower shell 4 of the housing is provided with a circular center hole 4a for exposing a center core 10 towards the exterior, and an arcuate groove 4b concentric with the rotary shutter 7. A shutter knob 7b is fixedly disposed on the rotary shutter 7 so as to project from the aforementioned arcuate groove 4b. The shutter knob 7b travels along the arcuate groove 4b, thereby opening and closing the rotary shutter 7. When the disk cartridge 1 is loaded into the disk drive, a rotary drive source of the disk drive supports the center core portion 10 exposed through the center hole 41 and rotates the information recording medium 5.

The information recording medium 5 is, for example, a magnetic disk of flexible thin plastic film having a magnetic layer applied thereon. The center core 10 is disposed at the central part of the information-recording medium 5 such that the upper surface 10a of the center core 10 is centrally secured to the lower surface of the information recording medium 5 via an adhesive member. This adhesive member comprises, for example, a double sided adhesive tape having a substrate of polyethylene terephthalate (PET) or non-woven fabric which is provided with an acrylic adhesive on each side thereof.

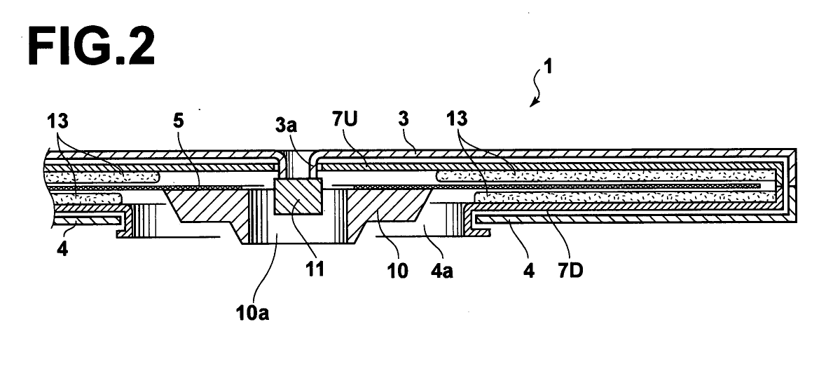

FIG. 2 is a schematic view of a part of the disk cartridge of the invention, illustrating the periphery of the center core 10. Referring to FIG. 2, the rotary shutter 7 is constituted by upper and lower shutter members 7U and 7D which are engaged with each other. The upper shutter member 7U is rotatably supported by a small-diameter cylinder 3a of the upper shell 3. The cylinder 3a projects inwardly from the lower surface of the upper shell 3. A retaining member 9 (called a center pin) is welded to the extremity of the cylinder 3a in order to prevent the upper shutter member 7U from falling off from the cylinder 3a. Meanwhile, the outer edge of the center hole 4a of the lower shell is caulked so that the lower shutter member 7D is rotatably supported.

To the facing surfaces of the upper and lower shutter members facing or opposite the information recording medium 5, liners L, L are respectively affixed. In FIG. 2, the liners L, L are respectively affixed to the entire facing surfaces of the upper and lower shutter members 7U, 7D. These liners L, L are constructed of, for example, a non-woven fabric of a material such as polyester, and serve to remove dirt deposited on the information recording medium 5 by coming into abutment with the information recording medium 5.

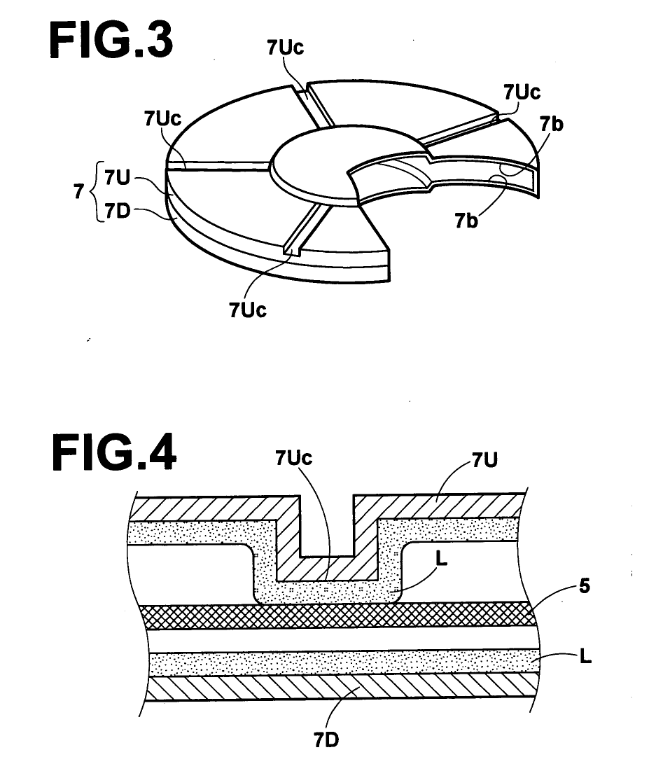

FIG. 3 is a perspective view showing an example of an external appearance of the rotary shutter 7. Referring to FIG. 3, the upper shutter member 7U has a plurality of protrusions 7Uc which are integrally formed with the rotary shutter 7. Specifically, the protrusions 7Uc are formed in relief on the facing surface of the shutter member 7U by stamping the shutter member 7U from the side away from the information recording medium 5. Each protrusion 7Uc is provided in the form of a ridge which extends linearly in a radial direction of the rotary shutter 7. The height of the protrusion 7Uc is uniform along its entire length.

The liners L, L are respectively affixed to the entire facing surfaces of the upper and lower shutter members 7U and 7D, and hence the liner L affixed to the upper shutter member 7U is also affixed to the protrusions 7Uc. In the liner L affixed to the facing surface of the upper shutter member 7U, each part of the liner L located directly on each protrusion 7Uc, instead of the entire liner L, is brought into abutment with the information recording medium 5 and remove dirt deposited on the information recording medium 5.

More specifically, in the space in which the information recording medium 5 is accommodated and rotated, as shown in FIG. 4, the dimension in the thickness direction at each of the portions where the protrusions 7Uc are provided is smaller than that of the remaining region. In turn, among the liner L affixed to the facing surface of the upper shutter member 7U, only the portions located directly on the protrusions 7Uc are being in contact with the information recording medium 5. As a result, the rotational resistance by the liner L affixed to the upper shutter 7U is reduced, so that the torque required for rotating the information recording medium 5 is kept low while reliably removing the dirt deposited on the information recording medium 5. When the protrusion 7Uc is provided to extend radially, the entire data recording region of the information recording medium 5 can be cleaned by the portions of the liner L located directly on the protrusions 7Uc.

In the embodiment shown in FIGS. 3 and 4, no protrusion 7Uc is formed on the lower shutter member 7D, and in turn the facing surface of the lower shutter member 7D is flat. Therefore, the entirety of the liner L affixed on the lower shutter member 7D is brought into contact with the information recording medium 5.

While this invention has been described with respect to certain illustrative and specific embodiments thereof, it should not be considered limited to such but may be used in other ways without departing from the spirit of the invention and the scope of the appended claims. While FIG. 3 illustrates an example in which each protrusion 7Uc has a uniform height along the entire length thereof, the height of the protrusion 7Uc may be different depending on location. For example, the height of the protrusion 7Uc at a portion closer to the radially inner end of the rotary shutter 7 (hereinafter referred to as “radially inner portion”) may be different from the height of the protrusion 7Uc at a portion closer to the radially outer end of the rotary shutter 7 (hereinafter referred to as “radially outer portion”). For example, a greater height of a radially outer portion of the protrusion 7Uc with respect to the height of a radially inner portion of the protrusion 7Uc results in a smaller torque required for rotating the information recording medium 5. Alternatively, a smaller height of a radially outer portion of the protrusion 7Uc with respect to the height of a radially inner portion of the protrusion 7Uc results in enhancing the dust removal efficiency at the data recording region of the information recording medium 5.

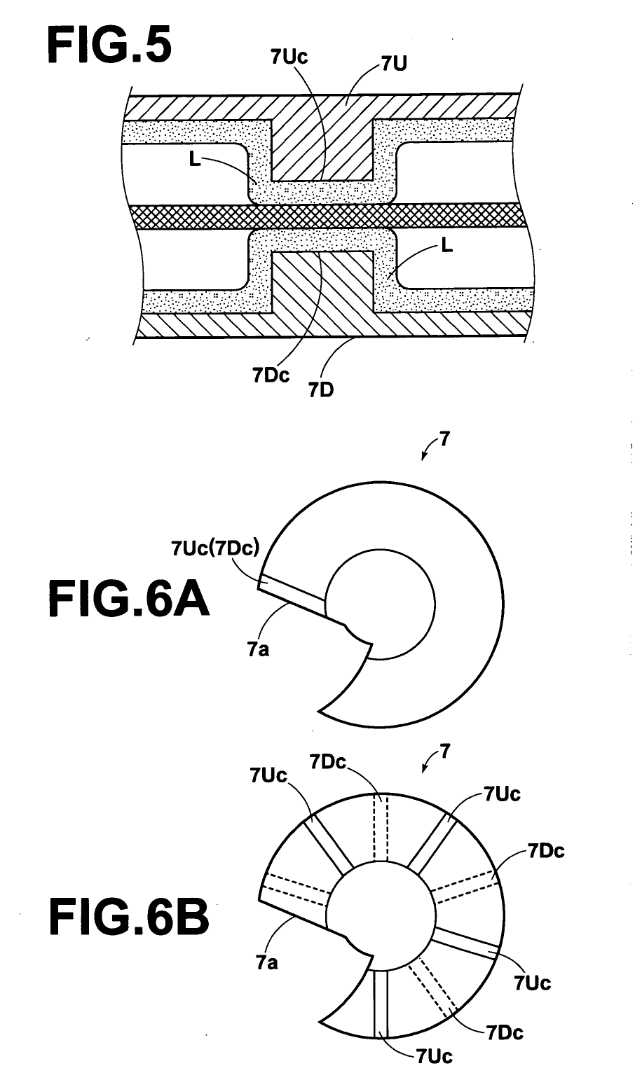

While FIGS. 3 and 4 illustrate an example of a rotary shutter 7 in which the protrusion 7Uc is provided only in the upper shutter member 7U, the protrusion may be provided only in the lower shutter member 7D. Alternatively, not only the upper shutter member 7U but also the lower shutter member 7D may be provided with a plurality of protrusions 7Dc. In this case, the protrusions 7Uc may be disposed facing the protrusions 7Dc as shown in FIG. 5 or may be disposed circumferentially offset from the protrusions 7Dc as shown in FIG. 6B. FIG. 5 illustrates a form of the protrusion 7Uc, 7Dc provided on each facing surfaces while maintaining the outer surface (i.e. the surface facing away from the information recording medium) flat, instead of the protrusion 7Uc, 7Dc provided by stamping the rotary shutter 7 from the outer surfaces thereof as shown in FIG. 3.

Further, the position where the protrusion is provided may be selected as desired regardless of the position and number of the protrusions shown in FIGS. 3 and 4. For example, a single protrusion 7Uc or 7Dc may be provided in an opening 7a as shown in FIG. 6A.

Still further, FIGS. 1 and 3 illustrate an example where the protrusion 7Uc is provided in the form of a ridge extending in a radial direction of the rotary shutter 7. However, protrusions may be provided in the manner of dispersed spots. In addition, while FIG. 2 illustrates an example where the liners L, L are respectively affixed to the entire facing surfaces of the upper and lower shutter members 7U and 7D on the side facing to the information recording medium, the liners L, L may be disposed only on the protrusion 7Uc (7Dc).

1. A disk cartridge comprising a disk-shaped information recording medium; and a flat housing in which the recording medium is rotatably accommodated, the housing including an opening to allow a read/write head of a drive unit to access a surface of the information recording medium, and a rotary shutter for opening and closing the opening,
wherein a protrusion is formed integrally with the rotary shutter on a facing surface of the rotary shutter on the side facing the information recording medium, and a liner for wiping off dirt deposited on the information recording medium is affixed to the protrusion.

2. The disk cartridge as defined in claim 1, wherein the protrusion extends in a radial direction of the rotary shutter.
